(19) United States
(12) Patent Application Publication
(10) Pub. No.: US 2022/0119229 A1
(43) Pub. Date: Apr. 21, 2022

(54) CRANE ANTI-COLLISION SYSTEM, METHOD, PROGRAM, AND MANUFACTURING METHOD

(71) Applicant: Konecranes Global Oy, Hyvinkää (FI)

(72) Inventors: Ville MANNARI, Hyvinkää (FI); Teemu PAASIKIVI, Hyvinkää (FI)

(73) Assignee: Konecranes Global Oy, Hyvinkää (FI)

(21) Appl. No.: 17/442,704

(22) PCT Filed: Mar. 24, 2020
(86) PCT No.: PCT/FI2020/050184

§ 371 Date: Sep. 24, 2021

(30) Foreign Application Priority Data
Mar. 27, 2019 (FI) 20195241

(51) Int. Cl. B66C 15/04; B66C 15/06; B66C 13/46; G01S 17/931; G01S 17/42; G01S 7/481

(52) U.S. Cl. CPC B66C 15/045; B66C 15/065; G01S 7/4817; G01S 17/931; G01S 17/42; B66C 13/46

(57) ABSTRACT

A crane anti-collision system, containing: a scanning apparatus installed in the crane, containing a laser scanner arranged to measure the optical distance to targets from the crane in the first direction of travel; and a detection apparatus arranged to automatically detect targets by the scanning apparatus. The detection apparatus is arranged for: defining by the scanning apparatus a three-dimensional reference zone of the goods handling area that is composed of the surface and vertical tolerance of the goods handling area; and detecting a target in the goods handling area on the basis that the height defined by the scanning apparatus differs from that of said reference zone. Further described is a control system, an anti-collision method, an anti-collision program, and a manufacturing method for an anti-collision system.

### FIELD

The aspects of the disclosed embodiments relates to a crane anti-collision system, control system, anti-collision method, anti-collision program, and a manufacturing method for an anti-collision system.

### BACKGROUND

This section will provide the reader with a useful background information. There is no intention, either express or implied, that the background art discussed in this section legally constitutes prior art.

Container cranes are used to move containers, such as 20- and 40-foot sea containers, for example, in harbours. Containers are handled typically in large numbers, consequently, taking into account the dimensions of the containers, container terminals require significant space. To assure the safety of automatic container handling, container yards are fenced and provided with access control in order that, even in a fault condition, no personal injuries would occur. An attempt is made to avoid also material damages, both to avoid damaging the materials being handled and to avoid slowing down the handling of containers.

For automatic crane anti-collision, various measuring devices are used, such as ultrasound and laser sensors, with which the distance of a moving crane to obstacles in the direction of movement are monitored. Measurement of distance by ultrasound is in itself simple and quite reliable, but with poor discrimination capabilities: from ultrasound measurement, it is not necessarily clear whether an obstacle lying in the front of the crane will remain in its path, or outside of it. Using measurement based on laser sensors, it has, in turn, been necessary to settle for a single point or line, or to constantly move the sensor and thus weaken the durability of the measurement solution in an environment subject to powerful jolts as well as all weather conditions. Moving parts also wear naturally, and they require maintenance, such as greasing, changing of wearing surfaces and cleaning in order to remain operational.

In addition to crane anti-collision, there is a need to detect persons and, preferably, also larger animals in the danger area of the crane. By means of reliable monitoring of the danger area relating to a crane, it would be possible to avoid or decrease the need for fencing the working area of the crane and/or the access control arrangements covering the working area of the crane.

The aspects of the disclosed embodiments are directed to avoid or obviate the above-mentioned disadvantages of the prior art, or to provide new alternatives or improvements to current techniques.

### SUMMARY

According to a first aspect of the disclosed embodiments, a crane anti-collision system is provided, comprising:

a scanning apparatus installed in a crane, comprising a laser scanner arranged to measure the optical distance to targets from the crane in the first direction of travel;

a detection apparatus arranged to automatically detect targets by the scanning apparatus,

characterized in that:

the detection apparatus is arranged for:
defining by the scanning apparatus a three-dimensional reference zone of the goods handling area that is composed of the surface and the vertical tolerance of the goods handling area; and
detecting a target in the goods handling area on the basis that the height defined by the scanning apparatus differs from that of said reference zone.

The laser scanner may be a 3D laser scanner. The 3D laser scanner may be a multilayer laser scanner. The 3D laser scanner may be a LiDAR (Light Detection and Ranging) scanner.

The anti-collision system may be adjustable. Adjusting may comprise changing the installation site of the laser scanner in the direction of height. Adjusting may comprise changing the vertical installation site of the laser scanner in the lateral direction.

The surface of the goods handling area may be approximated as a plane.

Tolerance may be defined such that, of the measurements of the laser scanner from the surface of the goods handling area, at least N% remain within the limits of tolerance, when the maximum allowed mass dimensioned for the crane is moved by the crane at the maximum possible acceleration or deceleration of the crane. N may be 50. N may be 90. N may be 95. N may be 99. N may be 99.9.

The scanning apparatus may be arranged to scan in the downward diagonal direction. The majority of the measurements of the scanning apparatus may be directed in the downward diagonal direction. The scanning apparatus may be arranged to scan in the downward diagonal direction such that the scanning apparatus receives the distance measurement information throughout its entire measurement area, either from the goods handling area or from targets in the goods handling area, when the scanning apparatus is installed in a crane working in the goods handling area. The scanning apparatus may be arranged to scan in the downward diagonal direction such that the scanning apparatus receives the distance measurement information throughout its entire measurement area, either from the goods handling area or from targets in the goods handling area, when the scanning apparatus is installed in a crane working in the goods handling area. The scanning apparatus may be arranged to scan in the downward diagonal direction at a minimum angle, which differs by no more than 0 or 5 or 10 or 20 degrees from the horizontal. The scanning apparatus may be arranged to scan in the downward diagonal direction at a maximum angle, which differs by no more than 5 or 10 or 20 or 30 or 45 or 60 or 69 degrees from the horizontal.

The detection apparatus may be arranged to initiate a hazard avoidance procedure, if the scanning apparatus does not receive distance measurement information from inside the reference zone from any part of the area measured by the scanning apparatus.

The hazard avoidance procedure may comprise issuing an audio signal. The hazard avoidance procedure may comprise issuing a light signal. The hazard avoidance procedure may comprise slowing down the movement of the crane. The hazard avoidance procedure may comprise an emergency stop of the crane. The hazard avoidance procedure may comprise raising the load higher to reduce the probability of the load colliding with a target. The hazard avoidance procedure may comprise changing the direction of the crane. The hazard avoidance procedure may comprise moving the load laterally in relation to the crane. The hazard avoidance procedure may comprise sending a notification to another crane and/or to the control system of the terminal or the terminal surveillance. The notification may comprise information regarding the location of a target, for example, the coordinates of a target.

The goods handling area may be, at least partially, a storage area managed by a crane. The goods handling area may be a container handling area for handling and storing ISO containers.

The detection apparatus may be arranged to identify deviations downwards from the reference zone of the goods handling area, such as a pit or subsidence created in the goods handling area. The detection apparatus may be arranged to identify one or more reference points or surfaces formed in the goods handling area. Said one or more reference points or surfaces may comprise a part or parts projecting from or extending into the goods handling area. The detection apparatus may be arranged to facilitate navigation of the crane by means of the detected one or more reference points or surfaces.

The scanning apparatus may comprise one or more laser scanners installed in the front end according to each primary direction of the crane. The primary directions may be forwards and backwards. The scanning apparatus may further comprise, in relation to the primary directions, one or more laser scanners installed to the side of the crane or to the side of the lifting element of the crane.

One or more, or all of the laser scanners of the scanning apparatus may be 3D laser scanners. The beam of the 3D laser scanner may be conical. The opening angle of the beam of the 3D laser scanner may be at least 20, 30, 40, 50, 90 or 180 degrees.

One or more of the laser scanners may be installed at a height of 5 m or more, 6 m or more, 8 m or more or 10 m or more.

One or more of the laser scanners may be at a height of 6 m or less, 9 m or less, or 12 m or less. The scanning apparatus may be arranged to scan in the plane of the goods handling area farther than the braking distance of a moving crane is, when the crane is fully loaded and at top speed.

The scanning apparatus may be installed so high and at a slightly downwards directed angle that the scanning apparatus is able to detect immobile targets in the path of the crane in time to avoid collisions. The scanning apparatus may be installed so low that it is possible to detect by the scanning apparatus a target in the path of the crane regardless of the position of the target, when the target is a reference unit or a crash test dummy. The crash test dummy may be a Hybrid III, a THOR or a SID-IIs. The reference unit may be a rectangular prism. The minimum diameter of the reference unit may be less than 0.1 m. The minimum diameter of the reference unit may be less than 0.15 m. The minimum diameter of the reference unit may be less than 0.2 m. The minimum diameter of the reference unit may be less than 0.25 m. The minimum diameter of the reference unit may be less than 0.3 m. The minimum diameter of the reference unit may be less than 0.4 m. The maximum diameter of the reference unit may be less than 2 m. The maximum diameter of the reference unit may be less than 1.5 m. The maximum diameter of the reference unit may be less than 1 m.

The installation site and accuracy of the 3D laser scanner may be selected such that the distance between measurement layers formed by the parallel measurement points or segments is 10 cm or less, 15 cm or less, 20 cm or less, 25 cm or less, 30 cm or less, 35 cm or less, or 40 cm or less.

The scanning apparatus may be installed such that, it is possible to detect by the scanning apparatus a target in the path of the crane and moving at the maximum speed V regardless of the position of the target, when the target is a reference unit or a crash test dummy. V may be 1 m/s. V may be 2 m/s. V may be 3 m/s. V may be 5 m/s. V may be 10 m/s. The anti-collision system may be arranged to be capable of stopping the crane before it would collide with a target moving at speed V.

The beams of the laser scanners may have one or more overlapping areas.

The beams of the laser scanners of the scanning apparatus may cover the path in front of the crane with at least such a lateral opening angle that the scanning apparatus covers the path of the crane also while the crane is turning.

The beams of the laser scanners of the scanning apparatus may cover parts of the path of the crane, in which the moving parts of the crane are below a height of M metres. M may be 1 m. M may be 2 m. M may be 3 m. M may be 4 m.

The beams of the laser scanners of the scanning apparatus may cover the path in front of the load.

The detection apparatus may be arranged to define the reference surface by the RANSAC (Random Sample Consensus) method.

The detection apparatus may comprise a classifier, which is arranged to discriminate targets detected in the goods handling area into different types based on the size and/or movement of the target. The detection apparatus may be arranged to perform a suitable hazard reduction procedure, from among a group of more than one different hazard reduction procedures, on the basis of the type of target. The detection apparatus may be arranged to perform a suitable hazard reduction procedure such that the target is detected by one laser scanner. The detection apparatus may be arranged to perform a suitable hazard reduction procedure such that if the target is located in the common area of two or more beams, detection of the target by even one laser scanner from the beams is enough to perform the hazard reduction procedure. Alternatively, performing a hazard reduction procedure may be bypassed, unless the target also occurs on another laser scanner scanning the common area. The operation mode of the detection apparatus in relation to a target in the common area may be changeable. This change can be made by the operator.

According to a second aspect of the disclosed embodiments, a crane control system is provided, comprising:

an automatic control for controlling the crane; and

an anti-collision system according to the first aspect of the disclosed embodiments.

The automatic control may be arranged to be capable of controlling the crane automatically to pick up a container or to put down a container.

According to a third aspect of the disclosed embodiments, a crane anti-collision method is provided, comprising the steps of:

measuring the optical distance to targets from the crane in the first direction of travel by a scanning apparatus installed in the crane and comprising a laser scanner; detecting targets automatically by the detection apparatus using the scanning apparatus,

characterized in that:
the detection apparatus is used for:
defining by the scanning apparatus a three-dimensional reference zone of the goods handling area that is composed of the surface and the vertical tolerance of the goods handling area; and
detecting a target in the goods handling area on the basis that the height defined by the scanning apparatus differs from that of said reference zone.

According to a fourth aspect of the disclosed embodiments, a crane anti-collision program is provided, comprising a computer program code arranged to perform, when executed on a computer, a method according to the third aspect.

According to a fifth aspect of the disclosed embodiments, a storage medium is provided, on which is saved a computer program according to the fourth aspect.

According to a sixth aspect of the disclosed embodiments, a manufacturing method for a crane anti-collision system is provided, comprising the steps of:

installing in the crane a scanning apparatus comprising a laser scanner arranged to measure the optical distance to targets from the crane in the first direction of travel;

providing the crane with a detection apparatus arranged to automatically detect targets by the scanning apparatus,

characterized in that:

the detection apparatus is arranged for:
defining by the scanning apparatus a three-dimensional reference zone of the goods handling area that is composed of the surface and the vertical tolerance of the goods handling area; and
detecting a target in the goods handling area on the basis that the height defined by the scanning apparatus differs from that of said reference zone.

Different embodiments of the present disclosure will be illustrated or have been illustrated only in connection with some aspects of the disclosed embodiments. A skilled person appreciates that any embodiment of an aspect of the disclosed embodiments may apply to the same aspect of the disclosed embodiments and other aspects alone or in combination with other embodiments as well.

### BRIEF DESCRIPTION OF THE FIGURES

In the following, the disclosed embodiments will be described by means of examples with reference to the accompanying drawings.

FIG. 1 shows schematically a rear view of a container crane, in which is installed a crane anti-collision system according to one embodiment;

FIG. 2 shows schematically a top view of the container crane of FIG. 1;

FIGS. 3 and 4 show schematically a front and side view of the beam of a laser scanner according to some embodiments;

FIG. 5 shows schematically a side view of the measuring points and reference zone of one crane anti-collision system;

FIG. 6 shows a simplified block diagram of a detection apparatus according to one embodiment of the present disclosure;

FIG. 7 shows a simplified diagram of an anti-collision method according to one embodiment of the present disclosure; and

FIG. 8 shows a simplified diagram of a manufacturing method according to one embodiment of the present disclosure.

### DETAILED DESCRIPTION

In the following description, like reference numerals are used to designate like parts or steps. It must be noted that the figures presented are not entirely to scale, and that they mainly serve only the purpose of illustrating the embodiments of the present disclosure.

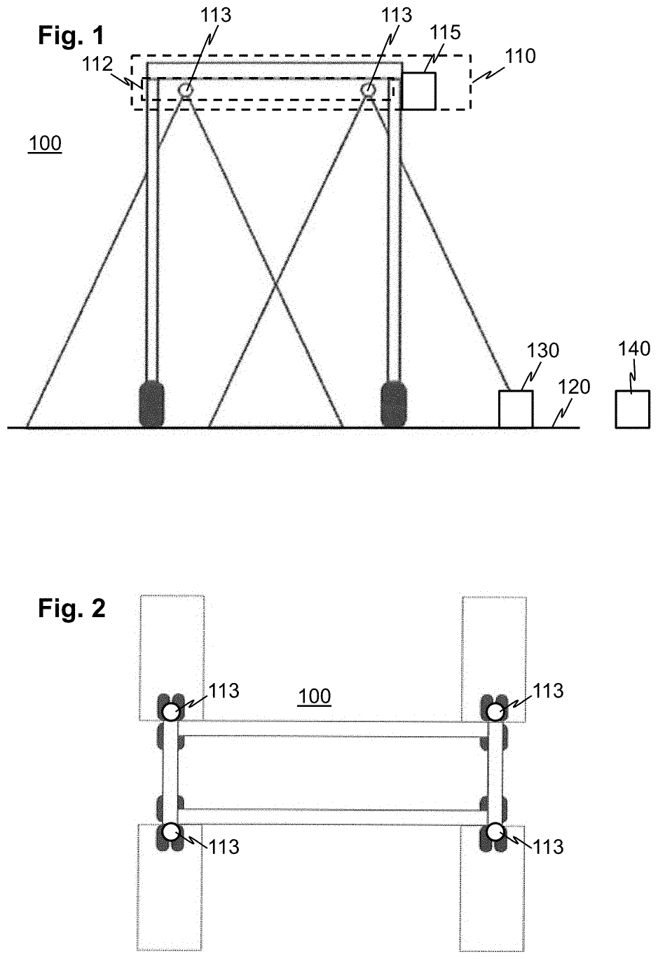

FIG. 1 shows schematically a rear view of a container crane 100 in a goods handling area 120, into which container crane is installed a crane anti-collision system 110 according to one embodiment. The anti-collision system 110 comprises a scanning apparatus 112 comprising one or more laser scanners 113. The laser scanner 113 is, for example, a 3D laser scanner, such as a multilayer laser scanner. The laser scanner 113 is arranged to measure the optical distance to targets 130 from the crane 100 in the first direction of travel. The anti-collision system 110 further comprises a detection apparatus 115. The detection apparatus 115 is arranged to define by the scanning apparatus 112 a three-dimensional reference zone 510 of a goods handling area (see FIG. 5) that is composed of the surface and the vertical tolerance of the goods handling area 120, and to automatically detect a target 130 in the goods handling area 120 on the basis that the height defined by the scanning apparatus 112 differs from that of said reference zone 510. The surface of the goods handling area may be approximated as a plane. Typically, goods handling areas are made relatively planar, but, in some embodiments, an attempt is made to form a surface corresponding to the shape of the actual goods handling area, for the purpose of more precisely defining the reference zone.

The crane further comprises a control system 140, such as an automatic crane control system, which is capable, for example, of loading and/or unloading containers to the goods handling area and/or to the container chassis of vehicles and/or off from these. For the sake of simplicity, the control system 140 is drawn in the vicinity of the crane in the plane of the goods handling area 120, even though, in practice, the control system 140 may be implemented in a server room or computer cloud or, for example, in a cabinet located in the crane 100.

The beam of the 3D laser scanner is, for example, conical. The opening angle of the beam of the 3D laser scanner may be at least 20, 30, 40, 50, 90 or 180 degrees.

FIG. 2 shows schematically a top view of the container crane 100 of FIG. 1. FIG. 2 shows the laser scanners installed in the primary directions of the crane. The crane 100 of FIG. 2 is provided with two laser scanners 113 in each of the directions of travel such that in connection with each wheel-supporting pillar is placed a laser scanner 113 directed forwards in the downward diagonal direction.

One or more of the laser scanners are installed, for example, to a height of 5 m or more, 6 m or more, 8 m or more, or 10 m or more.

One or more of the laser scanners is installed, for example, to a height of 6 m or less, 9 m or less or 12 m or less. In some embodiments, one or more laser scanners are to be moved from one installation site to another, or the installation site is to be freely selected from the structures of the crane. For example, the laser scanner may be moved lower or higher or to the side, for example, to take conditions into consideration. For example, during a foggy or particularly rainy time, one or more laser scanners may be placed lower and/or closer together. As another example, one or more laser scanners may be placed higher and possibly more in the downward diagonal direction in order to detect the lifting boom of a reach stacker possibly arriving or having arrived on a collision course. In one embodiment, the laser scanner is to be moved in the direction of height manually from the surface of the ground, for example, by an electrical or mechanical adjustment apparatus. Thus, the desired height can set easily and safely, for example, for servicing the laser scanner.

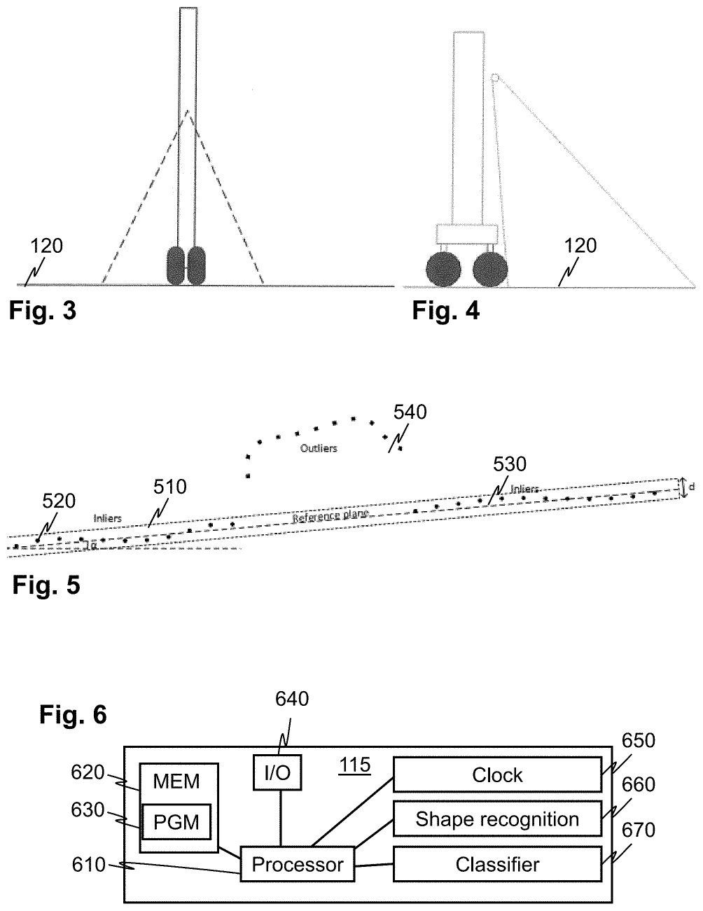

FIGS. 3 and 4 show schematically a front and side view of the beam of a laser scanner 113 according to some embodiments. In these figures, the laser scanner 113 is attached to the frame of the crane 100 above the wheel (in question is, for example, a RTG, RMG or straddle carrier) such that the beam of the laser scanner 113 measures the distance to the surface of the storage area 120 or targets 330 in the storage area 120 immediately forwards from the wheel and the frame of the crane. In some embodiments, the beam does not reach to the wheel or even to the frame of the crane in order that scanning may be directed farther along the path of the crane and that information regarding a collision risk may be obtained earlier. In this case, a target that has come directly in front of the crane can remain undetected. To prevent this, the crane may comprise a safety rail, bumper or other measurement apparatus, such as a short-range ultrasound measurement. In one embodiment, laser scanning is constantly maintained, even when the crane is stopped. In one embodiment, after a shutdown of the crane, a safe return to movement is assured manually, for example, using camera surveillance.

As is observed from FIGS. 3 and 4, the scanning apparatus 112 may be arranged to scan in the downward diagonal direction, for example, such that the majority or all of the measurements are directed in the downward diagonal direction. Thus, it is achieved that the scanning apparatus 112 receives the distance measurement information throughout its entire measuring area, either from the goods handling area 120 or from targets 140 in the goods handling area 120, when the scanning apparatus 112 is installed in a crane 100 working in the goods handling area 120. Thus may be obtained constantly changing information, whereby, as the crane 100 moves forward, on the basis of changes in the surface of the goods handling area 120 there should be created corresponding changes first to the front edge of the beam, and from there farther to other portions of the beam. In one embodiment, it is interpreted as a fault situation or collision hazard if, in the path of the crane 100 or a defined safety margin closer to the path of the crane 100, the scanning apparatus 112 does not form measurements located within the reference zone 510.

In one embodiment, the scanning apparatus 112 is installed so high and at such a slightly downwards directed angle that the scanning apparatus 112 is able detect immovable targets 130 in the path of the crane 100 and targets moving at the maximum speed V in time to avoid a collision. V is, for example, 1, 2, 3, 5 or 10 m/s. In one embodiment, the scanning apparatus 112 is installed so low that the scanning apparatus 112 is able to detect a target 130 in the path of the crane 100 regardless of the position of the target 130, when the target 130 is a reference unit or a crash test dummy.

In one embodiment, the installation site and the precision of the 3D laser scanners are selected such that the distance between the layers of the 3D laser scanners is 10 cm or less, 15 cm or less, 20 cm or less, 25 cm or less, 30 cm or less, 35 cm or less or 40 cm or less.

The beams of the laser scanners may have one or more overlapping areas. Due to the overlapping, the assurance of detecting collision risks may be increased.

For example, the detection apparatus can perform a suitable hazard reduction procedure if a target is detected by even one laser scanner. Alternatively, if the target is located in the common area of two or more beams, a second laser scanner is required to detect the target. Thus, false alarms may be reduced. In one embodiment, performing the hazard reduction procedure may be bypassed, unless the target also occurs on another scanner scanning the common area. The operation mode of the detection apparatus in relation to a target in the common area may be changeable. This change can be made by the operator, for example, according to a desired level of sensitivity (comprehensive monitoring of the targets or comprehensive monitoring of the targets with increased sensitivity). The operator can set the desired level of sensitivity, for example, according to the conditions, for example, taking into consideration one or more of the following: rain, fog, sandstorm, lighting, stray dogs, objects brought by the wind, maintenance work, the age of the apparatus, the presumed condition of the apparatus.

The beams of the laser scanners 113 of the scanning apparatus 112 may cover the path in the front of the crane 100 with at least such a lateral opening angle that the scanning apparatus 112 covers the path of the crane 100 also while the crane 100 is turning.

The beams of the laser scanners 113 of the scanning apparatus 112 may cover parts of the path of the crane, in which the moving parts of the crane are below a height of M metres. M may be 1 m. M may be 2 m. M may be 3 m. M may be 4 m.

The beams of the laser scanners 113 of the scanning apparatus 112 may cover the path in front of the load.

The detection apparatus may be arranged to identify deviations downwards from the reference zone of the goods handling area, such as a pit or subsidence created in the goods handling area. The detection apparatus may be arranged to identify one or more reference points or surfaces formed in the goods handling area that deviate upwards or downwards from the surface of the goods handling area. Said one or more reference points or surfaces may comprise a part or parts projecting from or extending into the goods handling area. The detection apparatus may be arranged to facilitate navigation of the crane by means of the detected one or more reference points or surfaces.

For example, into the goods handling area may be formed (for example, in the direction of travel of the crane) a groove, which may be defined by the detection apparatus. The groove is, for example, narrower than the wheel of the crane such that the groove does not hinder movement of the crane over the groove. The width of the groove may be, for example, 8 cm, 10 cm, 12 cm or 15 cm or less. The width of the groove may be 4 cm, 6 cm, 8 cm, 10 cm or 12 cm or more. The depth of the groove may be 2 cm, 4 cm, 6 cm or 8 cm or less. The depth of the groove may be 1 cm, 2 cm, 4 cm or 6 cm or more. In one embodiment, into the goods handling area is optionally or additionally formed (for example, in the direction of travel of the crane) a ridge or band, which may be defined by the detection apparatus. In one embodiment, into the goods handling area is optionally or additionally formed (for example, in the direction of travel of the crane) an optically discernible marking like a marking reminiscent of a centre line, which noticeably changes the reflection of the scanning apparatus. For example, the signal-noise ratio of the scanner device can improve at the marking even though the measured value itself would indicate the same distance from the laser scanner.

FIG. 5 shows schematically a side view of the measuring points 520 and reference zone 510, as well as the reference plane 530 of the anti-collision system 110 of the crane 100 of FIG. 1. FIG. 5 shows the measurements of the goods handling area and, defined on the basis of the measurements, the reference plane tilted at angle α. Powerful braking of the crane may slightly tilt the crane forwards and create a measurement like that of FIG. 5, in which the reference plane appears as an uphill tilted at angle α.

Also designated in FIG. 5 is the thickness d of the reference zone, which is, for example, 0.1 m or 0.2 m or 0.3 m or 0.4 m or 0.5 m. In the embodiment of FIG. 5, the reference zone is defined as uniformly thick. In another embodiment, the reference zone opens up like a wedge larger farther from the crane to account for the error of measurement increasing as a function of distance.

The detection apparatus 115 defines the reference zone 510 such that on the basis of the known geometry of the measurement points 520 and the scanning apparatus, the calculated surface of the goods handling area (for example, the average plane of the goods handling area) is defined, and to this surface is combined a specific vertical tolerance. Only measurements deviating from the reference zone may be considered indicative of targets 540 forming a collision risk. Thus, it is possible to eliminate unnecessary stops of the crane 100 caused by slight measurement errors, or even a plastic bag flying into the goods handling area 120.

The distances to the goods handling area 120 defined by scanning will change if the crane 100 tilts, for example, due to acceleration or braking. Tolerance may be defined such that, of the measurements of the laser scanner 113 from the surface of the goods handling area 120, at least N% remain within the limits of tolerance, when the maximum allowed mass dimensioned for the crane is moved by the crane 100 at the maximum possible acceleration or deceleration of the crane 100. N may be optimized to prevent unnecessary stops and with consideration for adequately assuring the probability of detecting targets 540 that are relevant in terms of anti-collision.

In one embodiment, the detection apparatus 115 is arranged to define the reference surface by the 530 RANSAC (Random Sample Consensus) method.

In one embodiment, the detection apparatus 115 comprises (or is arranged to form) a classifier, which is arranged to discriminate targets detected in the goods handling area 120 into different types based on the size and/or movement of the target. In the case of overlapping beams, the classifier may be arranged to utilize the detections of more than one laser scanner to perform a more detailed three-dimensional identification of a detected target.

The detection apparatus 115 may be arranged to perform a suitable hazard reduction procedure, from among a group of more than one different hazard reduction procedures, on the basis the type of target, such as for example, issuing an audio signal or a light signal, slowing down the movement or an emergency stop of the crane 100, raising the load higher, changing the direction of the crane 100 or moving the load laterally in relation to the crane 100. In one embodiment, the hazard avoidance procedure comprises sending a notification to another crane and/or the control system of the terminal or the terminal surveillance. The notification may comprise information regarding the location of a target, for example, the coordinates of a target.

FIG. 6 shows a simplified block diagram of the detection apparatus 115 according to one embodiment of the present disclosure. The detection apparatus comprises:

610. a processor or processing functionality (for example, a computer cloud as the functionality);

620. a memory and a computer program code 630 stored therein, which computer program code, when executed on the processor or processing functionality, is arranged to control the operation of the detection apparatus 115;

640. an information transfer interface or functionality for receiving information from the scanning apparatus 112 as well as for submitting information to the control system 140 of the crane 100;

650. a clock for measuring time;

660. shape recognition means; and

670. a classifier, which is arranged to discriminate targets detected in the goods handling area 120 into different types based on the size of the target 130 and/or the movement of the target 130.

In FIG. 6, the clock 650, the shape recognition means 660, and a classifier 670 are each drawn as separate blocks. Optionally, the processor or processing functionality 610 may implement any one, or two, or each one of these.

The shape recognition means are able to detect a moving target 130 from among several, possibly successive detections by means of shape recognition, even though the target 130 moves and/or the crane 100 moves. By means of measured distances to a detected moving target 130 as well as lateral locations, the moving state of the target 130 may be defined. For example, significantly successive detections may be combined with moments in time measured by the clock. On the basis of the defined movements and the time elapsed during these, the speed and possible acceleration of a moving target 130 may be defined, including the direction of movement of the target 130. After this, the detection apparatus 115 can define a suitable hazard reduction procedure in relation to the moving target.

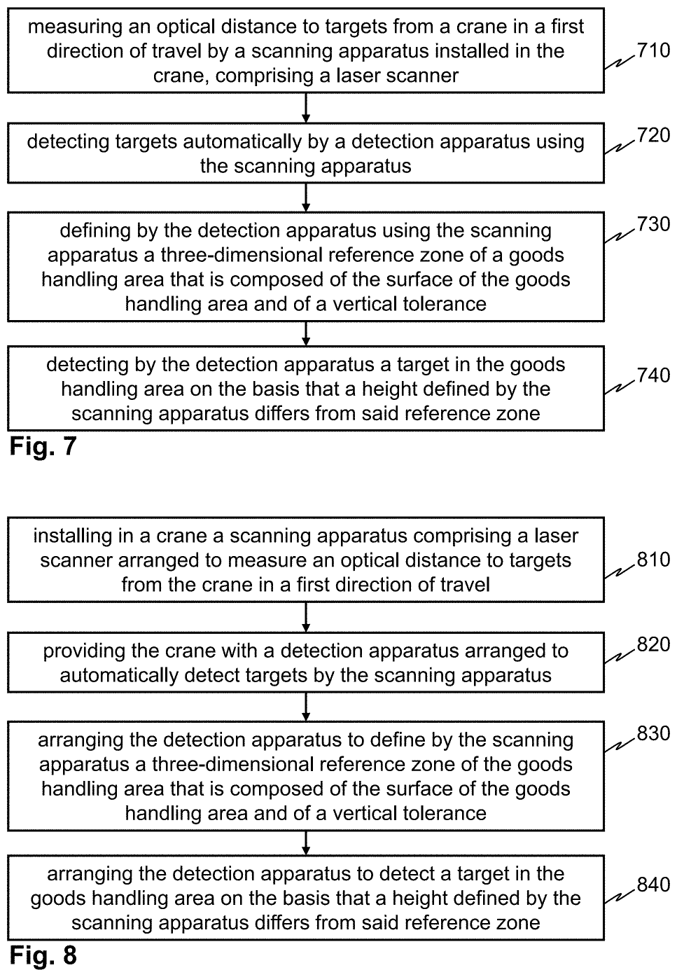

FIG. 7 shows a simplified diagram of an anti-collision method according to one embodiment of the present disclosure, comprising the steps of:

710. measuring the optical distance to targets from the crane in the first direction of travel by a scanning apparatus installed in the crane, comprising a laser scanner;

720. detecting targets automatically by the detection apparatus using a scanning apparatus;

730. defining by the detection apparatus using the scanning apparatus a three-dimensional reference zone of the goods handling area that is composed of the surface and vertical tolerance of the goods handling area; and

740. detecting by the detection apparatus a target in the goods handling area on the basis that the height defined by the scanning apparatus differs from that of said reference zone.

FIG. 8 shows a simplified diagram of a manufacturing method according to one embodiment of the present disclosure, comprising the steps of

810. installing in the crane a scanning apparatus comprising a laser scanner arranged to measure the optical distance to targets from the crane in the first direction of travel;

820. providing the crane with a detection apparatus arranged to automatically detect targets by the scanning apparatus;

830. arranging the detection apparatus to define by the scanning apparatus a three-dimensional reference zone of the goods handling area that is composed of the surface and vertical tolerance of the goods handling area; and

840. arranging the detection apparatus to detect a target in the goods handling area on the basis that the height defined by the scanning apparatus differs from that of said reference zone.

By means of the embodiments described above, an obstacle-free part of a goods handling area may be detected, and the surface of the area may be interpreted as free of obstacles. Further, the surface of the area forms a reference plane, which can be detected.

The foregoing description provides non-limiting examples of some embodiments of the present disclosure. It is clear to a person skilled in the art that the disclosed embodiments is not restricted to details presented, but that the disclosed embodiments can be implemented in other equivalent means.

Furthermore, some of the features of the afore-disclosed embodiments of this present disclosure may be used to advantage without the corresponding use of other features. As such, the foregoing description shall be considered as merely illustrative of the principles of the present disclosure, and not in limitation thereof. Hence, the scope of the disclosed embodiments is only restricted by the appended patent claims.

1. A crane anti-collision system comprising:
a scanning apparatus installed in a crane, comprising a laser scanner arranged to measure the optical distance to targets from the crane in the first direction of travel;
a detection apparatus arranged to automatically detect targets by the scanning apparatus;
wherein;
the detection apparatus is arranged for:
defining by the scanning apparatus a three-dimensional reference zone of the goods handling area that is composed of the surface and vertical tolerance of the goods handling area; and
detecting a target in the goods handling area on the basis that the height defined by the scanning apparatus differs from that of said reference zone.

2. The anti-collision system according to claim 1, wherein the laser scanner is a 3D laser scanner.

3. The anti-collision system according to claim 1, wherein:
the vertical tolerance is defined such that, of the measurements of the laser scanner from the surface of the goods handling area, at least N% remain within the limits of tolerance, when the maximum allowed mass dimensioned for the crane is moved by the crane at the maximum possible acceleration or deceleration of the crane; and
N is 95.

4. The anti-collision system according to claim 1, wherein:
the scanning apparatus is arranged to scan in the downward diagonal direction; and
the detection apparatus is arranged to initiate a hazard avoidance procedure, if the scanning apparatus does not receive distance measurement information from inside the reference zone from any part of the area measured by the scanning apparatus.

5. The anti-collision system according to claim 1, wherein the detection apparatus is arranged to identify deviations downwards from the reference zone of the goods handling area.

6. The anti-collision system according to claim 1, wherein the scanning apparatus comprises one or more laser scanners installed in the front end according to each primary direction of the crane.

7. The anti-collision system according to claim 1, wherein the scanning apparatus is installed so high and at a slightly downwards directed angle that the scanning apparatus is able to detect targets in the path of the crane in time to avoid collisions.

8. The anti-collision system according to claim 1, wherein the scanning apparatus is installed so low that the scanning apparatus is able to detect a target in the path of the crane regardless of the position of the target, when the target is a reference unit or a crash test dummy.

9. The anti-collision system according to claim 1, wherein the beams of the laser scanners of the scanning apparatus cover the path in the front of the crane with at least such a lateral opening angle that the scanning apparatus covers the path of the crane for the width required by the crane also while the crane is turning.

10. The anti-collision system according to claim 1, wherein the detection apparatus is arranged to define the reference surface by a (Random Sample Consensus) method.

11. The anti-collision system according to claim 1, wherein the detection apparatus comprises a classifier, which is arranged to discriminate targets detected in the goods handling area into different types based on the size of the target and/or the movement of the target.

12. A crane control system comprising:
an automatic control for controlling the crane; and
an anti-collision system according to claim 1.

13. A crane anti-collision method comprising the steps of:
measuring the optical distance to targets from the crane in the first direction of travel by a scanning apparatus installed in the crane and comprising a laser scanner;
detecting targets automatically by the detection apparatus using the scanning apparatus;
wherein
the detection apparatus is used for:
defining by the scanning apparatus a three-dimensional reference zone of the goods handling area that is composed of the surface and vertical tolerance of the goods handling area; and
detecting a target in the goods handling area on the basis that the height defined by the scanning apparatus differs from that of said reference zone.

14. A crane anti-collision program comprising a computer program code arranged to perform, when executed on a computer, a method according to claim 13.

15. A manufacturing method of a crane anti-collision system, comprising the steps of
installing in a crane a scanning apparatus comprising a laser scanner arranged to measure the optical distance to targets from the crane in the first direction of travel;
providing the crane with a detection apparatus arranged to automatically to detect targets by the scanning apparatus;
wherein;
the detection apparatus is arranged for:
defining by the scanning apparatus a three-dimensional reference zone of the goods handling area, composed of the surface and vertical tolerance of the goods handling area; and
detecting a target in the goods handling area on the basis that the height defined by the scanning apparatus differs from that of said reference zone.
